(19) United States
(12) Patent Application Publication
(10) Pub. No.: US 2023/0231807 A1
(43) Pub. Date: Jul. 20, 2023

(54) DEVICE, METHOD, SYSTEM AND PROGRAM FOR DISTRIBUTING TRAFFIC

(71) Applicant: NIPPON TELEGRAPH AND TELEPHONE CORPORATION, Tokyo (JP)

(72) Inventors: Hideo KAWATA, Musashino-shi, Tokyo (JP); Nobuhiro SHIBATA, Musashino-shi, Tokyo (JP); Keisuke YAMAGATA, Musashino-shi, Tokyo (JP); Shinichi YOSHIHARA, Musashino-shi, Tokyo (JP)

(73) Assignee: NIPPON TELEGRAPH AND TELEPHONE CORPORATION, Tokyo (JP)

(21) Appl. No.: 17/928,753

(22) PCT Filed: Jun. 5, 2020
(86) PCT No.: PCT/JP2020/022270

§ 371 Date: Nov. 30, 2022

(51) Int. Cl. H04L 45/00; H04L 45/02; H04L 45/18

(52) U.S. Cl. CPC H04L 45/66; H04L 45/02; H04L 45/18

(57) ABSTRACT

The disclosure has an object to allow local expansion without causing any loop. The disclosure is a system to which two nodes respectively belonging to different ring networks are connected, wherein the two nodes are connected to each other using a predetermined customized port, upon receipt of a predetermined unicast frame, one of the two nodes transmits the frame to another of the two nodes using the customized port, upon receipt of the predetermined unicast frame from the customized port, the other of the two nodes forwards the unicast frame, and upon receipt of a frame different from the predetermined unicast frame from the customized port, the other of the two nodes discards the frame.

### TECHNICAL FIELD

The disclosure relates to packet forwarding in a L2NW.

### BACKGROUND ART

In a L2NW (Layer2 NetWork) including a looped path (hereinafter, the looped path is called a ring network) in physical wiring, such as the Ethernet (R) ring protocol or the spanning tree protocol, a blocking point is set to cause no loop. Even when different ring networks are connected to each other, connection is required to logically achieve a tree structure at a relay node (setting a blocking point) in order to cause no loop (see Non-Patent Literatures 1 and 2). Accordingly, in the conventional art, for example, even when the traffic between certain nodes in different rings increases, the nodes cannot be directly connected to each other. Communication is required to be performed through a relay node in order to cause no loop.

On the other hand, since the Ethernet ring protocol and the like have a redundant configuration, the link bandwidth of the entire rings are required to be unique. Even when communication via the relay node increases, the bandwidth of the entire rings is required to be increased. Accordingly, there are problems in that facility cost is required and in that a flexible NW configuration that supports the traffic flow rate cannot be achieved.

### CITATION LIST

### Patent Literature

Patent Literature 1: Japanese Patent Laid-Open No. 2007-19698, Ring type redundant communication path control method

### Non-Patent Literature

Non-Patent Literature 1: IEEE 802.1D-1998 Edition MAC bridges (STP)
Non-Patent Literature 2: IEEE 802.1D-2004 Edition MAC bridges (RSTP)

### SUMMARY OF THE INVENTION

### Technical Problem

An object of the disclosure is to allow local expansion without causing any loop.

### Means for Solving the Problem

In the disclosure, when the traffic between specific nodes increases in the L2NW that uses the Ethernet ring protocol and the like, the nodes are directly connected to each other. For example, only specific frames destined for the nodes are allowed to be forwarded. Accordingly, local expansion can be achieved without causing any loop, and a flexible NW configuration that supports reduction in facility cost and the traffic flow rate can be achieved.

Specifically, a system according to the disclosure is a system to which two nodes respectively belonging to different ring networks are connected, wherein

the two nodes are connected to each other using a predetermined customized port,

upon receipt of a predetermined unicast frame, one of the two nodes transmits the frame to another of the two nodes using the customized port,

upon receipt of the predetermined unicast frame from the customized port, the other of the two nodes forwards the unicast frame, and

upon receipt of a frame different from the predetermined unicast frame from the customized port, the other of the two nodes discards the frame.

Specifically, a method according to the disclosure is

a method executed by a system to which two nodes respectively belonging to different ring networks are connected, wherein

the two nodes are connected to each other using a predetermined customized port,

upon receipt of a predetermined unicast frame, one of the two nodes transmits the frame to another of the two nodes using the customized port,

upon receipt of the predetermined unicast frame from the customized port, the other of the two nodes forwards the unicast frame, and

upon receipt of a frame different from the predetermined unicast frame from the customized port, the other of the two nodes discards the frame.

Specifically, a device according to the disclosure is

a communication device constituting L2NW, including:

a frame forwarding process unit that performs a process of forwarding a received main signal frame;

a port that is connected to a ring network, receives a frame from another communication device, transmits the frame to the frame forwarding process unit, and transmits, to the other communication device, the main signal frame received from the frame forwarding process unit;

a customized port that is connected to a ring network different from the ring network, forwards only a predetermined unicast frame, and forwards no non-unicast frame;

a customized-port-dedicated MAC address registration process unit that learns only a MAC address destined for the customized port, and notifies the frame forwarding process unit of the customized port as a destination port when a transmission destination MAC address of the main signal frame received by the frame forwarding process unit is registered;

a MAC address learning process unit that learns a MAC address destined for what is other than the customized port and a destination port, from a transmission source MAC address of the main signal frame received by the frame forwarding process unit, and notifies the frame forwarding process unit of the destination port, based on the destination MAC address of the main signal frame received by the frame forwarding process unit;

a customized port setting process unit that registers the MAC address with the destination port being set to the customized port, in the customized-port-dedicated MAC address registration process unit, and operates the frame forwarding process unit so as to transmit no non-unicast frame; and

a loop prevention process unit that discards the main signal frame, when the transmission destination MAC address of the main signal frame received from the customized port is not in a MAC address learning table of the MAC address learning process unit.

Specifically, a program in the disclosure is a program for executing a computer as each function unit included in the communication device according to the disclosure, and is a program for causing the computer to execute each step included in the communication method executed by the communication device according to the disclosure.

### Effects of the Invention

According to the disclosure, local expansion can be achieved without causing any loop. Consequently, a flexible NW configuration that supports reduction in facility cost and the traffic flow rate can be achieved.

### BRIEF DESCRIPTION OF DRAWINGS

FIG. 1 shows a L2NW connection configuration using a conventional art.

FIG. 2 shows a L2NW connection configuration using the disclosure.

FIG. 3 shows an example of a communication device according to a first embodiment.

FIG. 4 shows an example of a MAC address learning table.

FIG. 5 shows an example of customized port setting steps according to the first embodiment.

FIG. 6 shows an example of a forwarding process according to the first embodiment.

FIG. 7 shows an example of a communication device according to a second embodiment.

FIG. 8 shows an example of specific identifier setting steps according to the second embodiment.

FIG. 9 shows an example of a forwarding process according to the second embodiment.

FIG. 10 shows an example of a communication device according to a third embodiment.

FIG. 11 shows an example of a MAC address sharing signal transmission process.

FIG. 12 shows an example of a MAC address sharing signal reception process.

FIG. 13 shows an example of a communication device according to a fourth embodiment.

FIG. 14 shows an example of registering a MAC address in an external device.

FIG. 15 shows an example of an information table held by the external device.

FIG. 16 shows an example of obtaining MAC address of another communication device from the external device.

### DESCRIPTION OF EMBODIMENTS

Hereinafter, embodiments of the disclosure are described in detail with reference to the drawings. Note that the disclosure is not limited to the embodiments described below. The examples of these embodiments are exemplary ones. The disclosure can be implemented in modes where various modifications and improvements are applied on the basis of the knowledge of those skilled in the art. Note that configuration elements assigned the same symbols in the Description and the drawings indicate the same objects.

### RELATED ART

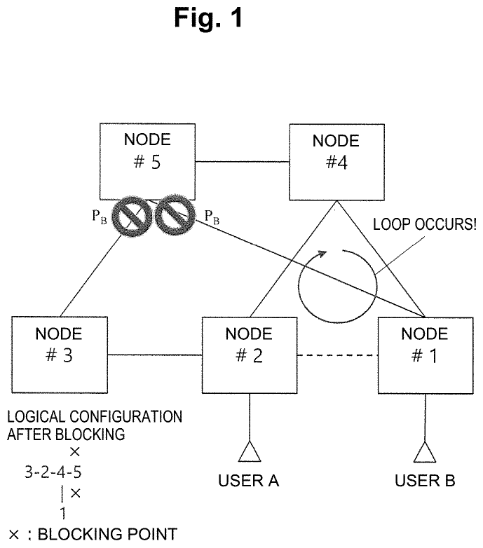

FIG. 1 shows a L2NW connection configuration using a related art of Patent Literature 1. In the L2NW using the Ethernet ring protocol according to Patent Literature 1, a logical tree configuration is adopted for the sake of communication between different ring networks. For example, as shown in FIG. 1, in a case where a ring network including nodes #2-#3-#4-#5 and a ring network including nodes #1-#4-#5 exist and a blocking point P_{B} is present at the relay node #5, a relay node (#4) is required to intervene.

The Ethernet ring protocol has a redundant configuration. Accordingly, the link bandwidth of the entire rings is required to be unique. For example, even when the traffic increases in a certain section (between nodes #1-#4) of the ring, the bandwidth of the entire ring (rings #1-#4-#5) is required to be increased.

On the other hand, if the nodes #1-#2 are directly connected so as to prevent passage through the certain section of the ring (between nodes #1-#4) having increased traffic, a loop (#1-#2-#4) occurs because there is no blocking point. Consequently, a flexible NW configuration supporting the traffic flow rate cannot be achieved.

### SUMMARY OF THE DISCLOSURE

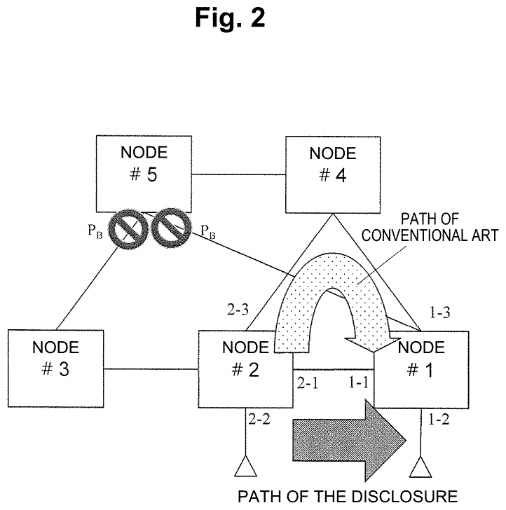

FIG. 2 shows a L2NW connection configuration using the disclosure. When the traffic increases only between the nodes #1 and #2, the nodes #1 and #2 are connected to each other without intervention of a relay node. 1-1 shown in the diagram indicates a specified port, and 1-2 indicates a destination port.

The disclosure describes a technique that can connect different ring networks to each other in a L2NW using the Ethernet ring protocol or the like without occurrence of any loop even in a case where the configuration is not a logical tree configuration.

The disclosure proposes the following three methods.

1. Set customized port forwarding only unicast (ports 1-1 and 2-1). That is, broadcast, unknown unicast, or multicast are not forwarded to the customized port.

2. Method of forwarding only frames having a specific identifier among unicasts to be forwarded to the customized port.

3. Method of autonomously sharing MAC (Media Access Control) address learning situation destined for designated ports (ports 1-2 and 2-2) between designated different nodes (nodes #1 and #2).

### Effects of the Disclosure

According to the disclosure, in the L2NW using the Ethernet ring protocol, local expansion is allowed to address increase in traffic between specified locations, which can reduce the additional installation cost.

The disclosure is also applicable not only to a L2NW using the Ethernet ring protocol but also L2NWs using STP (Spanning Tree Protocol) or RSTP (Rapid Spanning Tree Protocol), and exerts similar advantageous effects.

### First Embodiment

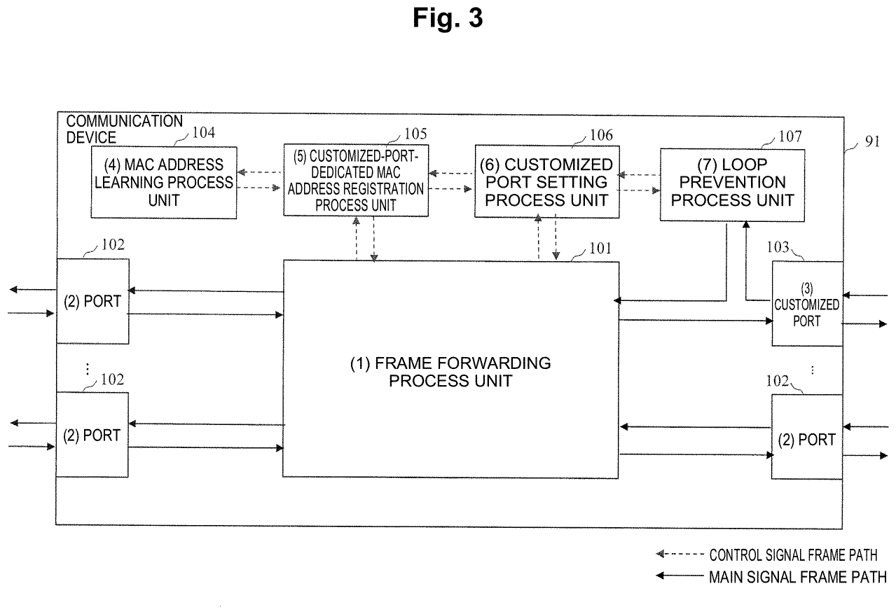

FIG. 3 shows an example of a communication device according to a first embodiment. A communication device 91 in the embodiment achieves path distribution of specific unicast traffic. Specifically, the communication device 91 according to the embodiment is a communication device constituting L2NW, and is a communication device that includes a frame forwarding process unit 101, ports 102, a customized port 103, a MAC address learning process unit 104, a customized-port-dedicated MAC address registration process unit 105, a customized port setting process unit 106, and a loop prevention process unit 107.

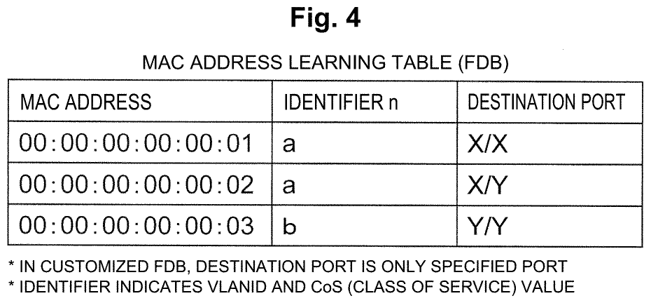

The MAC address learning process unit 104 holds a MAC address learning table. The customized-port-dedicated MAC address registration process unit 105 holds a customized-port-dedicated MAC address learning table. FIG. 4 shows an example of the MAC address learning table. The MAC address learning table is a table that defines MAC addresses destined for the ports 102. The customized-port-dedicated MAC address learning table is a table that defines MAC addresses destined for the customized port 103. In the disclosure, the MAC address learning table functions as an FDB (Forwarding DataBase). The customized-port-dedicated MAC address learning table is sometimes represented as customized FDB.

The frame forwarding process unit 101 performs a process of forwarding a received main signal frame.

The port 102 receives a frame from another communication device, transmits the frame to the frame forwarding process unit 101, and transmits, to the other communication device, the main signal frame received from the frame forwarding process unit 101. For example, in the case of the node #2 shown in FIGS. 1 and 2, the ports 102 are connected to the node #3 or the node #4.

The customized port 103 forwards only a designated unicast frame, and forwards no non-unicast frame. For example, in the case of the node #2 shown in FIGS. 1 and 2, the port 103 is connected to the node #1. In the case of the node #1 shown in FIGS. 1 and 2, the port 103 is connected to the node #2. As described above, the customized ports 103 are connected to each other in different ring networks.

The customized-port-dedicated MAC address registration process unit 105 learns only MAC addresses destined for the customized port 103, and creates a customized FDB. When the transmission destination MAC address of the main signal frame received by the frame forwarding process unit 101 is registered, the customized-port-dedicated MAC address registration process unit 105 notifies the frame forwarding process unit 101 of the customized port 103 as the destination port.

The MAC address learning process unit 104 learns the MAC addresses destined for what is other than the customized port 103, and the destination port, from the transmission source MAC address of the main signal frame received by the frame forwarding process unit 101, and creates the MAC address learning table. The MAC address learning process unit 104 notifies the frame forwarding process unit 101 of the destination port via the customized-port-dedicated MAC address registration process unit 105 on the basis of the transmission destination MAC address of the main signal frame received by the frame forwarding process unit 101.

The customized port setting process unit 106 registers, in the customized-port-dedicated MAC address registration process unit 105, the MAC address for registering the destination port in the customized port 103. Furthermore, the customized port setting process unit 106 operates the frame forwarding process unit 101 so as to forward no non-unicast frame.

The loop prevention process unit 107 discards the main signal frame, when the transmission destination MAC address of the main signal frame received from the customized port 103 is not in a MAC address learning table of the MAC address learning process unit 104. Access from the loop prevention process unit 107 to the MAC address learning table can be performed through the customized-port-dedicated MAC address registration process unit 105 and the customized port setting process unit 106.

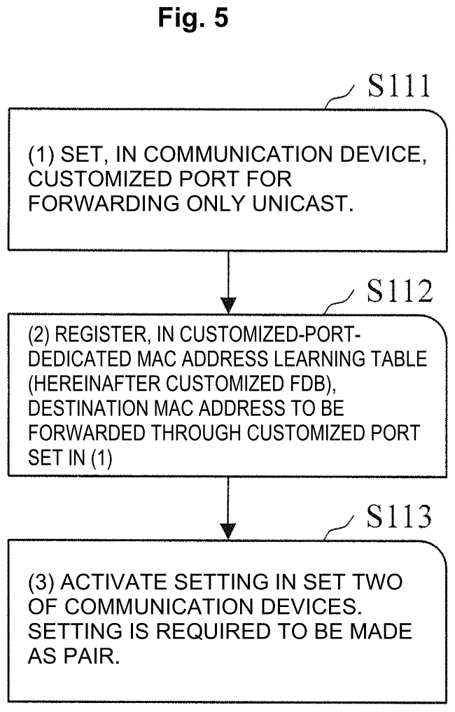

FIG. 5 shows an example of a step for setting a customized port for forwarding only unicast of the communication device.

Step S111: set, in the communication device 91, the customized port 103 for forwarding only the unicast.

Step S112: register, in the customized FDB, the destination MAC address to be forwarded through the set customized port 103.

Step S113: activate the setting in the set pair of communication devices 91. The pair of communication devices 91 are, for example, the nodes #1 and #2 shown in FIG. 2.

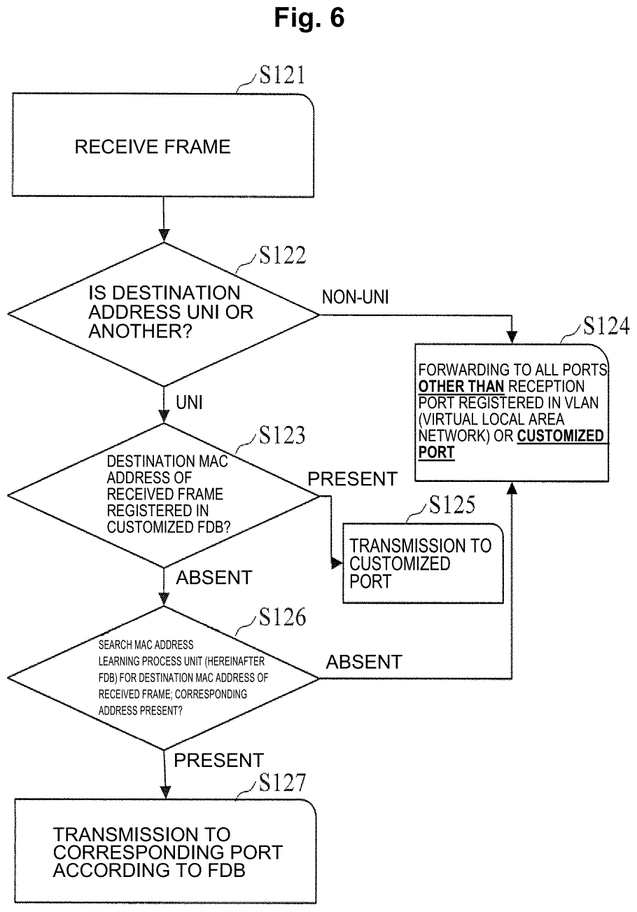

FIG. 6 shows an example of a forwarding process after the setting is activated. When a frame is received (S121), it is determined whether the destination MAC address is unicast or not (S122), and it is determined whether the destination MAC address of the received frame is registered in the customized FDB or not (S123). When a unicast frame with the registered destination MAC address, the frame is forwarded through the customized port according to the FDB (S125).

When the destination MAC address of the received frame is not registered in the customized FDB, the FDB of the MAC address learning process unit 104 is searched for the destination MAC address of the received frame, and presence or absence of the registration of the MAC address concerned in the FDB is determined (S126). When the MAC address concerned is registered in the FDB, transmission is performed to the port concerned according to the customized FDB (S127).

When the destination MAC address is not of the unicast in step S122 or when the MAC address concerned is not registered in the FDB in step S126, forwarding is performed to all the ports registered in the VLAN (Virtual Local Area Network) other than the reception port and the customized port (S124).

Note that in case the customized port setting process unit 106 detects a failure of the customized port 103, the unit masks the customized FDB (Forwarding Data Base) and performs the forwarding process according to the FDB. When the traffic is congested by switching of the path due to the failure of the customized port 103, a queuing process based on the classification is executed, and bandwidth control is executed by scheduling. When the customized port setting process unit 106 confirms the recovery from the failure of the customized port 103, the unit cancels the mask on the customized FDB.

The setting steps described above are executed and the setting is activated in the communication device 91, thereby preventing any non-unicast frame from being transmitted to the customized port 103 in the forwarding process. Accordingly, a loop due to a non-unicast (including a unicast having not been learned) frame can be prevented from occurring.

In the embodiment, the example is shown where the MAC address learning process unit 104 holds the FDB, and the customized port setting process unit 106 holds the customized FDB. However, the disclosure is not limited thereto. For example, in a case where a storing medium accessible from each function unit is included in the communication device 91, the FDB and the customized FDB may be stored in the storing medium. This is also applicable to the following embodiments.

### Second Embodiment

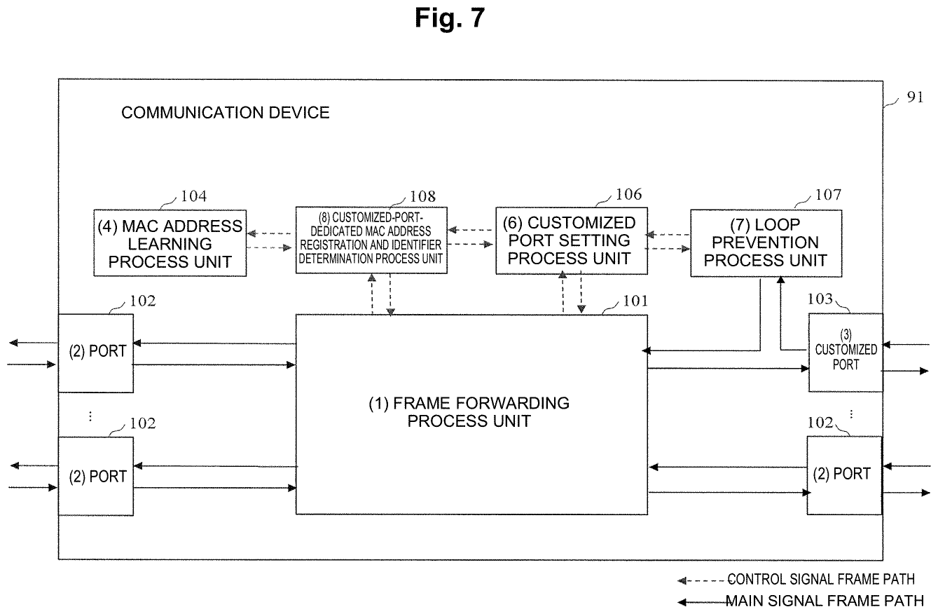

FIG. 7 shows an example of a communication device according to a second embodiment. The communication device 91 in the embodiment achieves path distribution with any identifier in specific unicast traffic. Specifically, the communication device 91 according to the embodiment is a communication device that includes a customized-port-dedicated MAC address registration and identifier determination process unit 108 instead of the customized-port-dedicated MAC address registration process unit 105 in the first embodiment.

The customized-port-dedicated MAC address registration and identifier determination process unit 108 includes the MAC address adopting the customized port 103 as the destination port, and a determination condition for a specific identifier, which are registered from the customized port setting process unit 106.

The customized-port-dedicated MAC address registration and identifier determination process unit 108 determines whether the main signal frame received by the frame forwarding process unit 101 satisfies the condition or not. When the condition is satisfied, the customized-port-dedicated MAC address registration and identifier determination process unit 108 notifies the frame forwarding process unit 101 of the destination port through the customized port 103. On the other hand, when the condition is not satisfied, the customized-port-dedicated MAC address registration and identifier determination process unit 108 issues a query to the MAC address learning process unit 104 and notifies the frame forwarding process unit 101 of a result of the query.

In the first embodiment, the condition forwarded through the customized port is only the destination MAC address. In the embodiment, besides the destination MAC address, an identifier is added as the determination condition. For example, even in the case with the same destination MAC address, forwarding through the customized port is allowed only for what has a priority 7 of PCP (Priority Code Point) or higher in the VLAN tag.

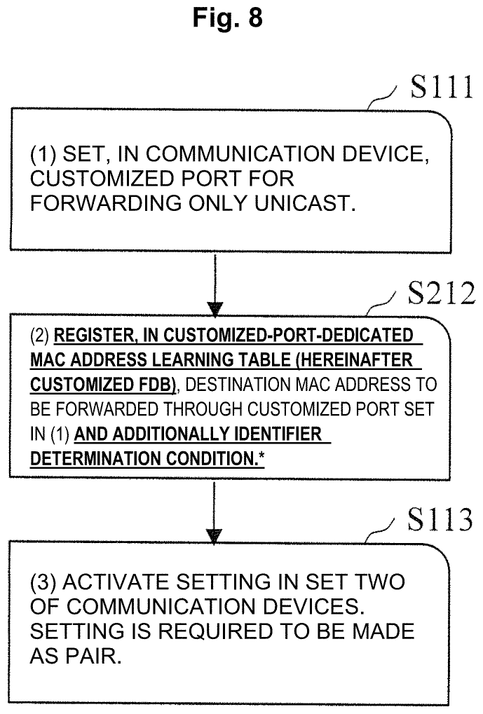

As shown in FIG. 8, according to the setting step, the determination condition for the identifier is added to the step S112 in the first embodiment, and they are registered in the customized FDB (S212).

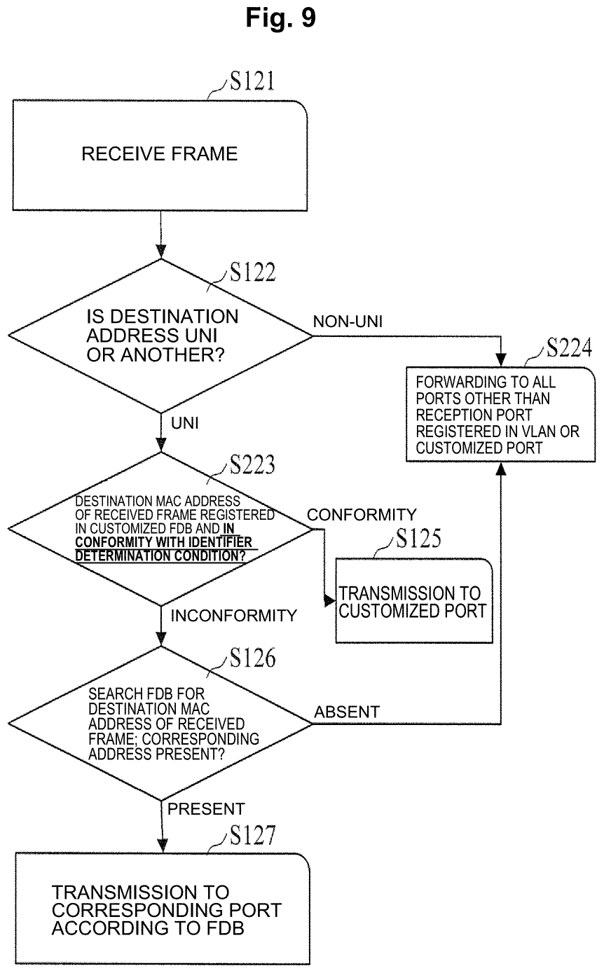

As shown in FIG. 9, in the forwarding process, when the destination address is of unicast (UNI in S122) and the destination MAC address of the received frame is registered in the customized FDB and the identifier determination condition is satisfied, transmission to the customized port is determined (S125). The other points are similar to those in the first embodiment.

### Third Embodiment

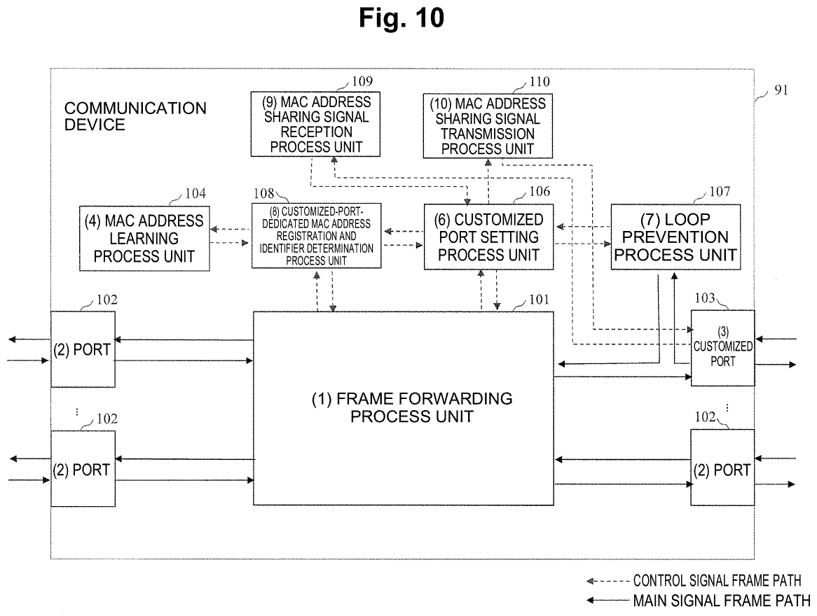

FIG. 10 shows an example of a communication device according to a third embodiment. The communication device 91 according to the embodiment allows the manual setting in the second embodiment to be omitted. Specifically, the communication device 91 according to the embodiment is a communication device that includes the communication device 91 according to the second embodiment, and further includes a MAC address sharing signal transmission process unit 110 and a MAC address sharing signal reception process unit 109.

The MAC address sharing signal transmission process unit 110 obtains a learning situation of the destination port designated from among the ports 102 in order to share MAC address learning information with another communication device, and transmits obtained MAC address information as a MAC address sharing signal frame through the customized port 103. The destination port learning situation is obtained from the MAC address learning process unit 104, through the customized port setting process unit 106 and the customized-port-dedicated MAC address registration and identifier determination process unit 108.

The MAC address sharing signal reception process unit 109 processes the MAC address sharing signal frame received from the customized port 103, and registers the frame in the customized-port-dedicated MAC address registration and identifier determination process unit 108 through the customized port setting process unit 106.

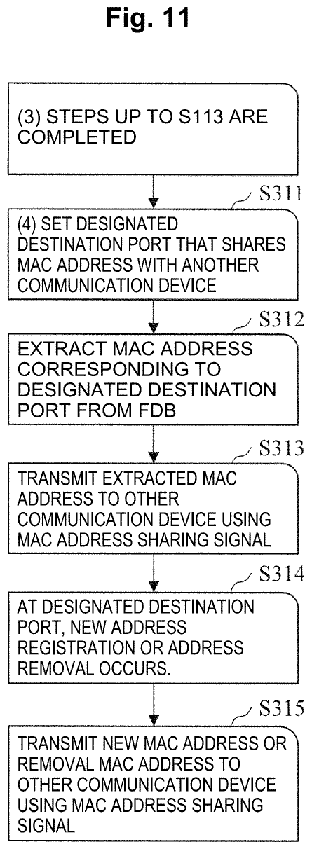

In the first and second embodiments, the unicast address to be forwarded through the customized port is required to be manually set. In the embodiment, a method of automatically registering the unicast address to be transferred through the customized port is described. Hereinafter, referring to FIG. 11, a method of automatically registering the unicast address to be forwarded through the customized port, using a MAC address sharing signal between the communication devices is described.

The MAC address sharing signal is subjected to a transmission process and a reception process. Here, a MAC address sharing signal transmission process is described. The steps up to S113 of activating the setting of the customized port for forwarding only unicast are completed. Here, steps S112 and S212 of registering the destination MAC address to be forwarded through the customized port are not required.

Next, the designated destination port that shares the MAC address with another communication device is set (S311). Subsequently, the processing is autonomously executed by the device.

The MAC address corresponding to the destination port set in step S311 is extracted from the FDB (S312). Subsequently, the extracted MAC address is transmitted to the other communication device using the MAC address sharing signal (S313).

When registration of a new address or removal of an address occurs at the destination port designated in the FDB (S314), the new MAC address or the removed MAC address is transmitted to the other communication device using the MAC address sharing signal (S315).

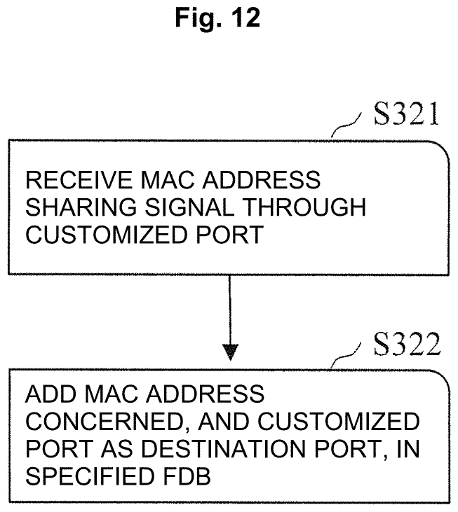

Next, referring to FIG. 12, the MAC address sharing signal reception process is described. When the MAC address sharing signal transmitted from the other communication device is received (S321), the MAC address concerned, and the customized port as the destination port are added to the specified FDB of the own node (S322).

The communication device 91 according to the embodiment may include the customized-port-dedicated MAC address registration process unit 105 described in the first embodiment instead of the customized-port-dedicated MAC address registration and identifier determination process unit 108. In this case, the MAC address sharing signal transmission process unit 110 obtains the destination port learning situation from the MAC address learning process unit 104, through the customized-port-dedicated MAC address registration process unit 105.

### Fourth Embodiment

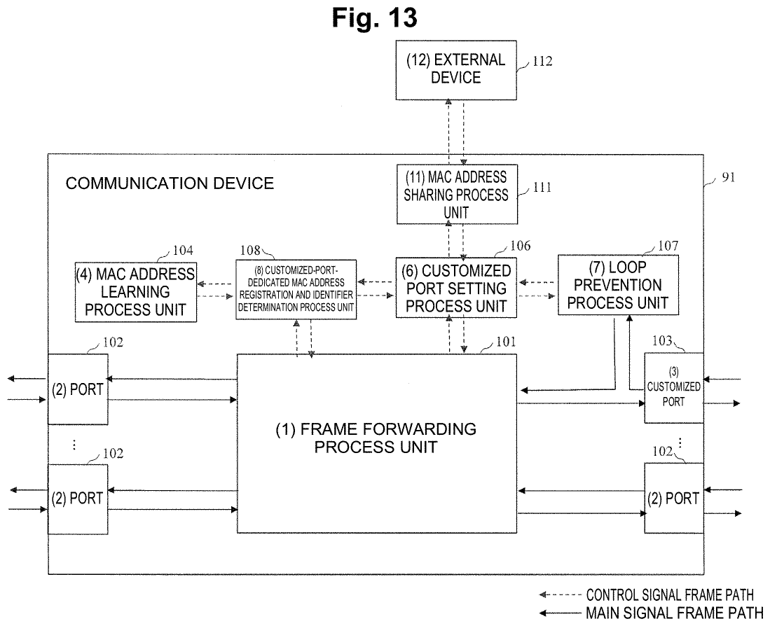

FIG. 13 shows an example of a communication device according to the embodiment. The communication device 91 according to the embodiment allows the manual setting in the second embodiment to be omitted. Specifically, the communication device 91 according to the embodiment is a communication device that includes the communication device 91 according to the second embodiment, and further includes a MAC address sharing process unit 111.

The MAC address sharing process unit 111 obtains the learning situation of the destination port designated from among the ports 102 from the MAC address learning process unit 104, and transmits the situation to an external device 112, for sharing the MAC address learning information in the own node with another communication device.

The MAC address sharing process unit 111 issues a query about the designated MAC address learning information in the other communication device to the external device 112, registers the information in the customized-port-dedicated MAC address registration and identifier determination process unit 108 through the customized port setting process unit 104. Here, the MAC address learning process unit 104 obtains the destination port learning situation through the customized port setting process unit 106 and the customized-port-dedicated MAC address registration and identifier determination process unit 108.

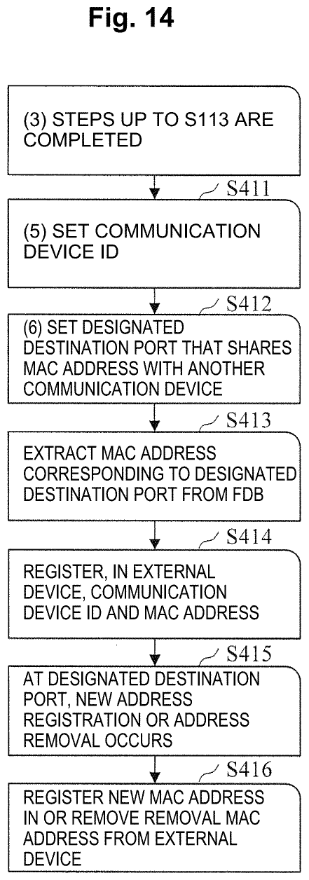

In the embodiment, a method of registering a unicast address for forwarding to the customized port using the communication device 91 and the external device 112 is described. The method includes a process of registering the MAC address in the external device 112, and a process of obtaining the MAC address of another communication device from the external device 12. Here, referring to FIG. 14, the process of registering the MAC address in the external device 112 is described.

The steps up to S113 of activating the setting of the customized port for forwarding only unicast are completed. Here, steps S112 and S212 of registering the destination MAC address to be forwarded through the customized port are not required.

Next, the communication device ID (IDentification) of the own device is set (S411). Next, the designated destination port that shares the MAC address with another communication device is set (S412). The MAC address corresponding to the destination port set in step S412 is extracted from the FDB (S413). Subsequently, the communication device 91 registers, in the external device 112, the communication device ID of the own device and the extracted MAC address (S414).

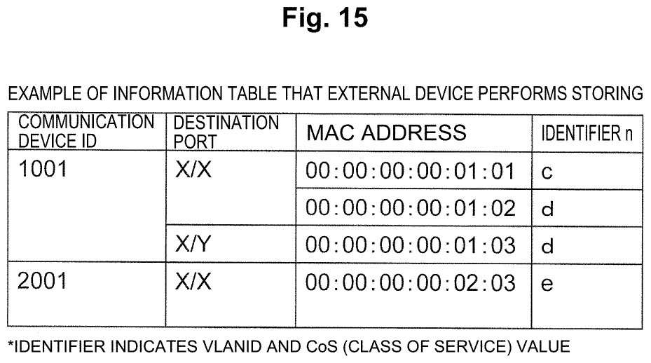

FIG. 15 shows an example of an information table held by the external device. When the situation of the FDB is changed, with occurrence of registration of a new address or removal of an address at the designated destination port (S415), the new MAC address is registered in or the removed MAC address is removed from the external device 112 (S416).

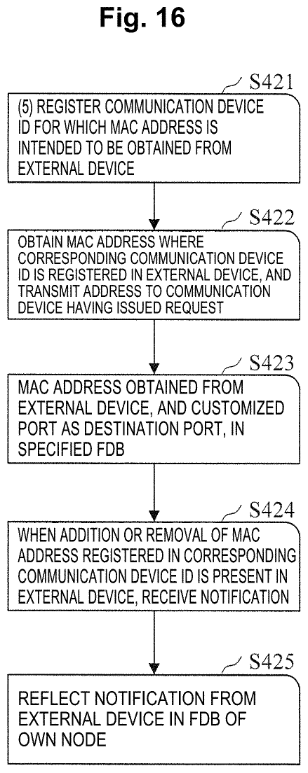

Next, referring to FIG. 16, the process of obtaining the MAC address of the other communication device from the external device 112 is described.

In the communication device 91, the communication device ID for which the MAC address is intended to be obtained is registered in the external device 112 (S421). The external device 112 obtains the MAC address where the communication device ID concerned is registered. Upon receipt of the request issued by the communication device 91, the external device 112 transmits the obtained MAC address to the communication device having issued the request (S422). The communication device 91 registers, in the FDB, the MAC address obtained from the external device 112, and registers the MAC address and the destination port in the customized port (S423). If the MAC address has been already registered in the FDB, only the destination port is overwritten on the customized port. When addition or removal of the MAC address registered for the communication device ID is performed in the external device 112, the external device 112 notifies the communication device 91 having issued the request (S424). The communication device 91 having received the notification reflects the notification in the FDB of the own node (S425).

The communication device 91 according to the embodiment may include the customized-port-dedicated MAC address registration process unit 105 described in the first embodiment instead of the customized-port-dedicated MAC address registration and identifier determination process unit 108. In this case, the MAC address sharing signal transmission process unit 110 obtains the destination port learning situation from the MAC address learning process unit 104, through the customized-port-dedicated MAC address registration process unit 105.

The device of the disclosure can be achieved also by a computer and a program. The program may be recorded in a recording medium, or provided via a network. This is applicable to the following embodiment. Specifically, the disclosure may achieve the communication device 91 by causing a computer to function as at least any of the frame forwarding process unit 101, the MAC address learning process unit 104, the customized-port-dedicated MAC address registration process unit 105, the customized port setting process unit 106, the loop prevention process unit 107, the customized-port-dedicated MAC address registration and identifier determination process unit 108, the MAC address sharing signal reception process unit 109, the MAC address sharing signal transmission process unit 110, and the MAC address sharing process unit 111.

### INDUSTRIAL APPLICABILITY

The disclosure is applicable to information communication industries.

### REFERENCE SIGNS LIST

101 Frame forwarding process unit
102 Port
103 Customized port
104 MAC address learning process unit
105 Customized-port-dedicated MAC address
registration process unit
106 Customized port setting process unit
107 Loop prevention process unit
108 Customized-port-dedicated MAC address registration and identifier determination process unit
109 MAC address sharing signal reception process unit
110 MAC address sharing signal transmission process unit
111 MAC address sharing process unit
112 External device
91 Communication device

1. A system to which two nodes respectively belonging to different ring networks are connected, wherein
the two nodes are connected to each other using a predetermined customized port,
upon receipt of a predetermined unicast frame, one of the two nodes transmits the frame to another of the two nodes using the customized port,
upon receipt of the predetermined unicast frame from the customized port, the other of the two nodes forwards the unicast frame, and upon receipt of a frame different from the predetermined unicast frame from the customized port, the other of the two nodes discards the frame.

2. A method executed by a system to which two nodes respectively belonging to different ring networks are connected, wherein the two nodes are connected to each other using a predetermined customized port,
upon receipt of a predetermined unicast frame, one of the two nodes transmits the frame to another of the two nodes using the customized port,
upon receipt of the predetermined unicast frame from the customized port, the other of the two nodes forwards the unicast frame, and
upon receipt of a frame different from the predetermined unicast frame from the customized port, the other of the two nodes discards the frame.

3. A communication device constituting L2NW, comprising:
a frame forwarding process unit that performs a process of forwarding a received main signal frame;
a port that is connected to a ring network, receives a frame from another communication device, transmits the frame to the frame forwarding process unit, and transmits, to the other communication device, the main signal frame received from the frame forwarding process unit;
a customized port that is connected to a ring network different from the ring network, forwards only a predetermined unicast frame, and forwards no non-unicast frame;
a customized-port-dedicated MAC address registration process unit that learns only a MAC address destined for the customized port, and notifies the frame forwarding process unit of the customized port as a destination port when a transmission destination MAC address of the main signal frame received by the frame forwarding process unit is registered;
a MAC address learning process unit that learns a MAC address destined for what is other than the customized port and a destination port, from a transmission source MAC address of the main signal frame received by the frame forwarding process unit, and notifies the frame forwarding process unit of the destination port, based on the destination MAC address of the main signal frame received by the frame forwarding process unit;
a customized port setting process unit that registers the MAC address with the destination port being set to the customized port, in the customized-port-dedicated MAC address registration process unit, and operates the frame forwarding process unit so as to transmit no non-unicast frame; and
the loop prevention process unit that discards the main signal frame, when the transmission destination MAC address of the main signal frame received from the customized port is not in a MAC address learning table of the MAC address learning process unit.

4. The device according to claim 3, further comprising a customized-port-dedicated MAC address registration and identifier determination process unit in which a MAC address adopting the customized port as the destination port and a determination condition for a specific identifier are registered from the customized port setting process unit and which determines whether the main signal frame received by the frame forwarding process unit satisfies the registered condition or not, notifies the frame forwarding process unit of the destination port when the condition is satisfied, and issues a query to the MAC address learning process unit and notifies the frame forwarding process unit of a result of the query when the condition is not satisfied.

5. The device according to claim 3, further comprising:
a MAC address sharing signal transmission process unit that obtains, from the MAC address learning process unit, a learning situation of the destination port designated from among the ports in order to share MAC address learning information with the other communication device, and transmits obtained MAC address information as a MAC address sharing signal frame through the customized port; and
a MAC address sharing signal reception process unit that receives the MAC address sharing signal frame from the customized port, and registers the frame in the customized-port-dedicated MAC address registration process unit.

6. The device according to claim 3, further comprising a MAC address sharing process unit that obtains, from the MAC address learning process unit, a learning situation of the destination port designated from among the ports, and transmits the learning situation to the external device, in order to share MAC address learning information in an own node with the other communication device, obtains MAC address learning information in the other communication device from the external device, and registers the information in the customized-port-dedicated MAC address registration process unit.

7. A non-transitory computer-readable medium having computer-executable instructions that, upon execution of the instructions by a processor of a computer, cause the computer to function as the communication device according to claim 3.
